(19) United States
(12) Patent Application Publication
(10) Pub. No.: US 2003/0011843 A1
(43) Pub. Date: Jan. 16, 2003

(54) Wavelength drop with integral optical amplifier

(76) Inventor: Steven J. Maas, Austin, TX (US)

Correspondence Address: PGS AMERICAS, INC., 16010 BARKER'S PIONT LANE, SUITE 300, HOUSTON, TX, 77079, US

(21) Appl. No.: 09/902,508

(22) Filed: Jul. 10, 2001

(51) Int. Cl. H04J 14/02

(52) U.S. Cl. 359/127; 359/130

(57) ABSTRACT

A fiber optic signal separator for separating and amplifying signal components from multiplexed signal using a three port optical circulator, a grating and integral signal amplification components is described. Another example embodiment of the signal separator uses a four port optical circulator, one or more grating and integral optical amplification components. A signal multiplexer using a three port optical circulator, a grating and integral signal amplification components is described. Another example embodiment of the signal multiplexer uses a four port optical circulator, one or more gratings and optical amplification components for integral amplification of the signal.

### BACKGROUND OF THE INVENTION

Optical signal transmission systems commonly employ signal multiplexing and later separation of the multiplexed signals' components in order to distribute the many different signal components to desired branches of a communication system. To achieve signal multiplexing and later separation, configurations exist that employ optical circulators. But problems exist with existing configurations: size, complexity of the associated equipment, and poor signal to noise ratio of the signals. These problems are especially critical to overcome in seismic data transmission systems where thousands of signals from seismic sensors are transmitted using WDM, FDM, or TDM techniques or a combination of techniques. The number of data channels in the seismic systems is very large requiring continuous improvements in the indicated areas. Therefore, there is a need for optical signal separators and multiplexers with integral amplifiers that can improve the signal quality with a minimum number of components. Such devices are valuable in optical sensor systems where a large number of channels are a fact of life.

### SUMMARY OF THE INVENTION

According to one aspect of the present invention, an apparatus for separating signals from a wavelength multiplexed signal is provided. In one example embodiment, the apparatus comprises an optical circulator having a first port positioned and arranged to receive the wavelength multiplexed signal, a second port positioned and arranged to output the wavelength multiplexed signal, and a third port positioned and arranged to output signals input at the second port. The apparatus further comprises an optical pump optically coupled to the second port; a fiber amplifier optically coupled to the optical pump; and a spectrally selective reflecting grating optically coupled to the fiber amplifier.

In a second aspect of the invention, an apparatus for separating signals from a wavelength multiplexed signal is provided. In one example embodiment, the apparatus comprises an optical circulator having a first port positioned and arranged to receive an optical pump input, a second port positioned and arranged to output signal received from the first port and to receive the wavelength multiplexed signal through a fiber amplifier, a third port positioned and arranged to output signals input at the second port and receiving input signals, and a fourth port positioned and arranged to output signals input at the third port. The apparatus further comprises, an optical pump optically coupled to the first port; a fiber amplifier optically coupled to the second port; and a spectrally selective reflecting grating optically coupled to the third port.

According to still a further aspect of the invention, a system of separating signals from a wavelength multiplexed signal using an optical circulator is provided, wherein the optical circulator has a first port positioned and arranged to receive the wavelength multiplexed signal, a second port positioned and arranged to output the wavelength multiplexed signal, and a third port positioned and arranged to output signals input at the second port, and wherein the example embodiment of the system comprises a means for receiving the wavelength multiplexed signal from the second port. The system further comprises a means for amplifying the wavelength multiplexed signal, wherein an amplified signal results, and a means for reflecting a component of the amplified signal, the component having a selected wavelength, into the second port, wherein the component exits through the third port.

In still a further aspect of the invention, still another embodiment of a system of separating optical signals from a wavelength multiplexed signal using an optical circulator is provided, wherein the optical circulator, in one example embodiment, comprises a first port positioned and arranged to receive an optical pump input, a second port positioned and arranged to output signal received from the first port and to receive the wavelength multiplexed signal through a fiber amplifier, a third port positioned and arranged to output signals input at the second port and receiving input signals, and a fourth port positioned and arranged to output signals input at the third port. The system further comprises a means for amplifying and receiving the wavelength multiplexed signal in the second port, wherein an amplified signal results, a means for outputting the amplified signal from the third port, and means for reflecting a component of the amplified signal, said component having a selected wavelength, into the third port, wherein the component exits through the fourth port.

An example method of separating signals from a wavelength multiplexed signal using an optical circulator is also provided, wherein the optical circulator has a first port positioned and arranged to receive the wavelength multiplexed signal, a second port positioned and arranged to output the wavelength multiplexed signal, and a third port positioned and arranged to output signals input at the second port, and wherein the method comprises receiving the wavelength multiplexed signal from the second port, amplifying the wavelength multiplexed signal, wherein an amplified signal results, and reflecting a component of the amplified signal, the component having a selected wavelength, into the second port, wherein the component exits through the third port.

Another aspect of the invention is a method of separating optical signals from a wavelength multiplexed signal using an optical circulator is provided, wherein the optical circulator has a first port positioned and arranged to receive an optical pump input, a second port positioned and arranged to output signal received from the first port and to receive the wavelength multiplexed signal through an optical pump, a third port positioned and arranged to output signals input at the second port and receiving input signals, and a fourth port positioned and arranged to output signals input at the third port, wherein the method comprises amplifying and receiving the wavelength multiplexed signal in the second port, wherein an amplified signal results. The method further comprises outputting the amplified signal from the third port, and reflecting a component of the amplified signal, said component having a selected wavelength, into the third port, wherein the component exits through the fourth port.

In another aspect of the invention, an apparatus for multiplexing optical signals is provided. In one example embodiment, the apparatus comprises an optical circulator having a first port positioned and arranged to receive a first signal, a second port positioned and arranged to output the first signal and receive input signals, and a third port positioned and arranged to output signals input at the second port. The apparatus further comprises an optical pump optically coupled to the second port, a fiber amplifier optically coupled to the optical pump, and a spectrally selective reflecting grating optically coupled to the fiber amplifier.

According to yet another aspect of the invention, an apparatus for multiplexing optical signals is provided. The apparatus comprises, in one example, an optical circulator having a first port positioned and arranged to receive an optical pump input, a second port positioned and arranged to receive the optical pump input and receive an input signal, a third port positioned and arranged to output signals input at the second port and receive input signals, and a fourth port positioned and arranged to output signals input at the third port. The apparatus further comprises a first spectrally selective reflecting grating to reflect the optical pump input optically coupled to the second port, a fiber amplifier optically coupled to the third port, and a second spectrally selective reflecting grating, to reflect the signal input in the second port, optically coupled to the fiber amplifier.

In a still another aspect of the invention, a system of multiplexing optical signals using an optical circulator is provided, and in one example, the optical circulator comprises a first port positioned and arranged to receive a first signal, a second port positioned and arranged to output the first signal and receive input signals, and a third port positioned and arranged to output signals input at the second port, and wherein the system comprises a means for receiving the first signal from the second port, a means for amplifying the first signal, wherein an amplified first amplified signal results. The system further comprises a means for reflecting the first amplified signal back into the second port; means for amplifying a second signal, wherein a second amplified signal results, and a means for inputting the amplified second signal into the second port; and means for outputting a multiplexed signal through the third port.

According to an even further aspect of the invention a system of multiplexing optical signals using an optical circulator is provided. In an example embodiment, the optical circulator comprises a first port positioned and arranged to receive an optical pump input, a second port positioned and arranged to receive the optical pump input and receive a first signal, a third port positioned and arranged to output signals input at the second port and receive input signals, and a fourth port positioned and arranged to output signals input at the third port, and wherein the example embodiment system comprises a means for receiving the first signal from the third port, a means for amplifying the first signal, wherein an amplified first signal results. The system further comprises a means for reflecting the first signal back into the third port, a means for amplifying a second signal, wherein an amplified second signal results, a means for inputting the second signal into the third port, and a means for outputting a multiplexed signal through the fourth port.

According to a still another aspect of the invention a method of multiplexing optical signals using an optical circulator having a first port positioned and arranged to receive a first signal, a second port positioned and arranged to output the first signal, and a third port positioned and arranged to output signals input at the second port is provided, wherein the method comprises receiving the first signal from the second port; amplifying the first signal, wherein an amplified first signal results. The method further comprises reflecting the amplified signal back into the second port, amplifying a second signal, wherein an amplified second signal results, inputting the amplified second signal into the second port, and outputting a multiplexed signal through the third port.

According to yet another aspect of the invention a method of multiplexing optical signals using an optical circulator having a first port positioned and arranged to receive an optical pump input, a second port positioned and arranged to receive the optical pump input and receive a first signal, a third port positioned and arranged to output signals input at the second port and receive input signals, and a fourth port positioned and arranged to output signals input at the third port is provided, wherein the method comprises receiving the first signal from the third port and amplifying the first signal, wherein an amplified first signal results. The method further comprises reflecting the first signal back into the third port, amplifying a second signal, wherein an amplified second signal results, inputting the second signal into the third port, and outputting a multiplexed signal through the fourth port.

### BRIEF DESCRIPTION OF THE DRAWINGS

FIG. 1 shows a schematic of the apparatus of a first example embodiment of the present invention for amplifying multiplexed signals and separating signal from a multiplexed signal and reamplifying separated signal.

FIG. 2 shows a schematic of the apparatus of a second example embodiment of the present invention for amplifying multiplexed signals and for separating signal from a multiplexed signal.

FIG. 2A shows a schematic of the apparatus of an additional example embodiment using two three-port circulators for amplifying multiplexed signals and for separating signal from a multiplexed signal.

FIG. 3 shows a schematic of the system of a first example embodiment of the present invention for amplifying multiplexed signals, and separating signal from a multiplexed signal.

FIG. 4 shows a schematic of the system of a second example embodiment of the present invention for amplifying multiplexed signals, and separating signal from a multiplexed signal.

FIG. 5 shows a schematic of the apparatus of a first example embodiment of the present invention for multiplexing signals.

FIG. 6 shows a schematic of the apparatus of a second example embodiment of the present invention for multiplexing signals.

FIG. 7 shows a schematic of the system of a first example embodiment of the present invention for multiplexing signals.

FIG. 8 shows a schematic of the system of a second example embodiment of the present invention for multiplexing signals.

### DESCRIPTION OF EXAMPLE EMBODIMENTS OF THE INVENTION

Now referring to FIG. 1, one example embodiment of the invention is seen in which an apparatus 10 is provided for separating signals from a wavelength multiplexed signal 25. According to the illustrated embodiment, the apparatus 10 comprises an optical circulator 20, for example an optical circulator 20 having model number CIR10AN32N-00 manufactured by New Focus, Inc. Other optical circulators 20 will occur to those of skill in the art without departing from the scope of the present invention. The apparatus 10 further comprises the optical circulator 20 having a first port 30 positioned and arranged to receive the wavelength multiplexed signal 25, a second port 35 positioned and arranged to output the wavelength multiplexed signal 25, and a third port 40 positioned and arranged to output signal 27 input at the second port 35. The apparatus 10 further comprises an optical pump 45 optically coupled to the second port 35. Examples of optical pumps 45 include a 980 nm and 1480 nm semiconductor diode laser or Raman-type lasers, including for example the 1480 nm semiconductor pump laser known by model number SL5612-XB manufactured by ExceLight Communications, Inc., and the Raman-type laser known as the “Streamline-RL” manufactured by Spectra-Physics, Inc. Other optical pumps 45 will occur to those of skill in the art without departing from the scope of the present invention.

Still further, the apparatus 10 comprises a fiber amplifier 50 optically coupled to the optical pump 45. Examples of fiber amplifiers 50 useful with embodiments of the invention include purpose-built or custom-built optical amplifiers fabricated with erbium-doped fiber available from Lucent Technologies, Inc. Other examples of fiber amplifiers 50 include fiber amplifiers 50 sometimes referred to in the industry as “gainblocks” as manufactured, for example, by Corning, Inc. or JDS Uniphase Corporation. Again, other examples of fiber amplifiers 50 will occur to those of skill in the art. The apparatus 10 further comprises a spectrally selective reflecting grating 55 optically coupled to the fiber amplifier 50, wherein examples of the spectrally selective reflecting grating 55 include reflecting gratings 55 manufactured by Corning, Inc., JDS Uniphase Corporation, and ExceLight Communications, Inc. Other examples of spectrally selective reflecting gratings 55 will occur to those of skill in the art without departing from the scope of the present invention.

Still referring to FIG. 1, in one of the embodiments of the invention, the fiber amplifier 50 comprises an erbium doped fiber amplifier, and the optical pump 45 further comprises the erbium doped fiber amplifier 50. Other dopants and combinations of dopants will occur to those of skill in the art. In yet another embodiment, the spectrally selective reflecting grating 55 comprises a fiber Bragg grating. In still another embodiment, the fiber Bragg grating 55 is integrally built in with the fiber amplifier 50. Other gratings will occur to those of skill in the art.

In the illustrated example embodiment shown in FIG. 1, the erbium doped fiber amplifier 50 twice amplifies the signal 27 that is separated from the input signal 25. The advantage of double signal amplification, integral with the operation of signal separation, improves signal noise ratio over a predetermined signal path.

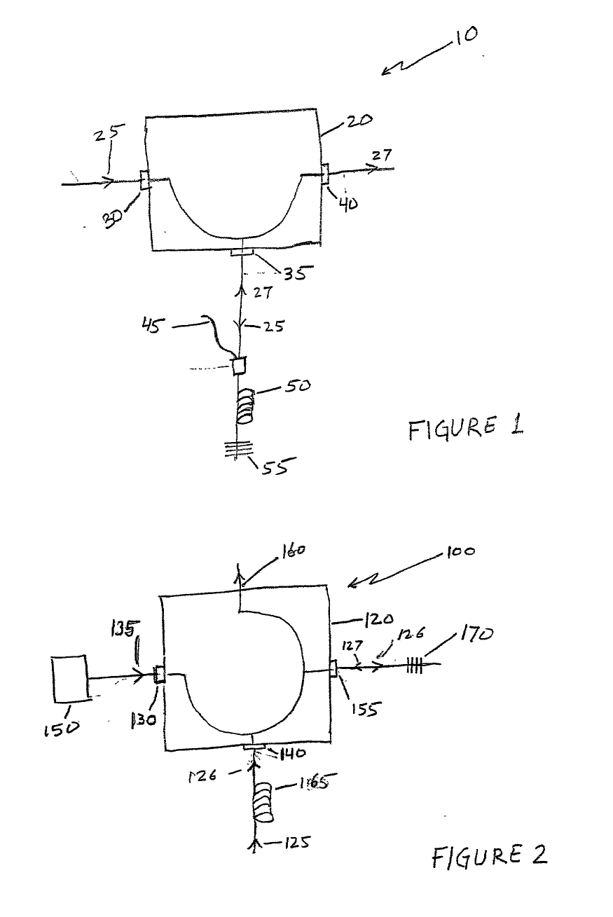

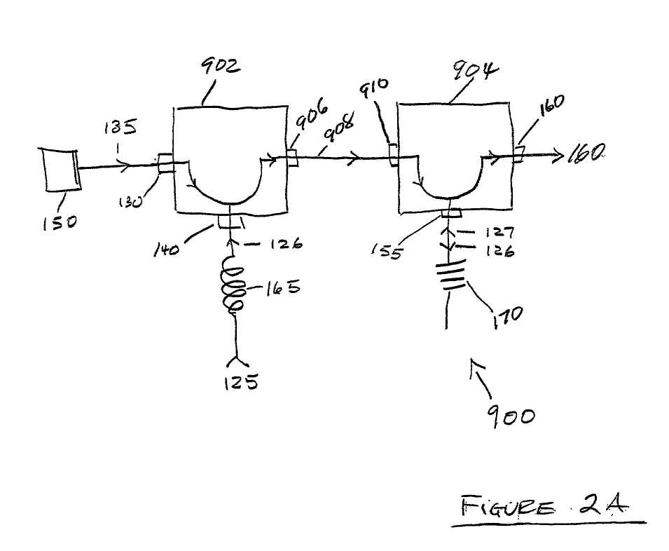

Now referring to FIG. 2, another example embodiment of the invention is seen in which an apparatus 100 is provided for separating signals from a wavelength multiplexed signal 125. According to the illustrated embodiment, the apparatus 100 comprises an optical circulator 120, for example an optical circulator 120 having model number CIR10AN32N-00 manufactured by New Focus, Inc. Other optical circulators 120 will occur to those of skill in the art without departing from the scope of the present invention. The apparatus 100 further comprises the optical circulator 120 having a first port 130 positioned and arranged to receive an optical pump input 135, a second port 140 positioned and arranged to receive the wavelength multiplexed signal 125 through a fiber amplifier 165, a third port 155 positioned and arranged to output signals input at the second port 140 and receiving input signals, and a fourth port 160 positioned and arranged to output signals input at the third port 155. The apparatus 100 further comprises an optical pump 150 optically coupled to the first port 135. Examples of optical pumps 150 include a 980 mn and 1480 nm semiconductor diode laser or Raman-type lasers, including for example the Raman-type laser known as the “Streamline-RL” manufactured by Spectra-Physics, Inc. Other optical pumps 150 will occur to those of skill in the art without departing from the scope of the present invention.

Still further, the apparatus 100 comprises a fiber amplifier 165 optically coupled to the second port 140. Examples of fiber amplifiers 165 useful with embodiments of the invention include purpose-built or custom-built optical amplifiers fabricated with erbium-doped fiber available from Lucent Technologies, Inc. Other examples of fiber amplifiers 165 include fiber amplifiers 50 sometimes referred to in the industry as “gainblocks” as manufactured, for example, by Corning, Inc. or JDS Uniphase Corporation. Again, other examples of fiber amplifiers 165 will occur to those of skill in the art. The apparatus 100 further comprises a spectrally selective reflecting grating 170 optically coupled to the third port 155, wherein examples of the spectrally selective reflecting grating 170 include reflecting gratings 170 manufactured by Corning, Inc., JDS Uniphase Corporation, and ExceLight Communications, Inc. Other examples of spectrally selective reflecting gratings 170 will occur to those of skill in the art without departing from the scope of the present invention.

Referring still to FIG. 2, in one embodiment of the invention the optical pump 150 is optically coupled to the first port 130. The fiber amplifier 165 in the example embodiment comprises an erbium doped fiber amplifier. The erbium doped fiber amplifier 165 is integrally built in the second port 140 in some embodiments and separately attached in others, as will will be understood by those of skill in the art. In the example embodiment, the spectrally selective reflecting grating 170 is a fiber Bragg grating, integrally built in at the third port 155. Again, the erbium doped fiber amplifier 165 amplifies the signal the input signal 125 prior to separating the signal component 127.

Now referring to FIG. 2A, another example embodiment of the invention is seen in which an apparatus 900 is provided for separating signals from a wavelength multiplexed signal 125. According to the illustrated embodiment, the apparatus 900 comprises two three-port optical circulators 902, 904. An optical circulator useful with the illustrated embodiment includes, for example, an optical circulator having model number CIR10AN32N-00 manufactured by New Focus, Inc. Other optical circulators will occur to those of skill in the art, use of all such optical circulators being well within the scope of the present invention. The apparatus 900 further comprises the first optical circulator 902 having a first port 130 positioned and arranged to receive an optical pump input 135, a second port 140 positioned and arranged to receive the wavelength multiplexed signal 125 through a fiber amplifier 165, and a third port 906 positioned and arranged to couple 908 the optical pump input and the wavelength multiplexed signal to the second circulator 904.

The apparatus 900 further includes the second optical circulator 904 having a first port 910 positioned and arranged to receive the coupled optical pump input and the wavelength multiplexed signal from the first optical circulator 902, a second port 155 positioned and arranged to output signals 126 input at the first port 910 and receive input signals 127, and a third port 160 positioned and arranged to output signals input at the second port 155. The apparatus 900 further comprises an optical pump 150 optically coupled to the first port 135 of the first circulator 902. Examples of optical pumps 150 include 980 nanometer and 1480 nanometer semiconductor diode lasers or Raman-type lasers, including for example the Raman-type laser known as the “Streamline-RL” manufactured by Spectra-Physics, Inc. Other optical pumps will occur to those of skill in the art without departing from the scope of the present invention.

Still further, the apparatus 900 comprises a fiber amplifier 165 optically coupled to the second port 140 of the first circulator 902. Examples of fiber amplifiers 165 useful with embodiments of the invention include purpose-built or custom-built optical amplifiers fabricated with erbium-doped fiber available from Lucent Technologies, Inc. Other examples of fiber amplifiers 165 include fiber amplifiers sometimes referred to in the industry as “gainblocks” as manufactured, for example, by Corning, Inc. or JDS Uniphase Corporation. Again, other examples of fiber amplifiers 165 will occur to those of skill in the art without departing from the scope of the present invention. The apparatus 900 further comprises a spectrally selective reflecting grating 170 optically coupled to the second port 155 of the second circulator, wherein examples of the spectrally selective reflecting grating 170 include reflecting gratings manufactured by Corning, Inc., JDS Uniphase Corporation, and ExceLight Communications, Inc. Other examples of spectrally selective reflecting gratings will occur to those of skill in the art without departing from the scope of the present invention.

Referring still to FIG. 2, in one embodiment of the invention the optical pump 150 is optically coupled to the first port 130 of the first circulator 902. The fiber amplifier 165 in the example embodiment of FIG. 2A comprises an erbium doped fiber amplifier. The erbium doped fiber amplifier 165, in some embodiments, is integrally built into the second port 140 of the first circulator. In other embodiments, the fiber amplifier 165 is separately attached. In the example embodiment, the spectrally selective reflecting grating 170 is a fiber Bragg grating, integrally built into the second port 155 of the second circulator. Again, in a manner similar to the four-port circulator embodiments described above, the erbium doped fiber amplifier 165 amplifies the input signal 125 prior to separating the signal component 127.

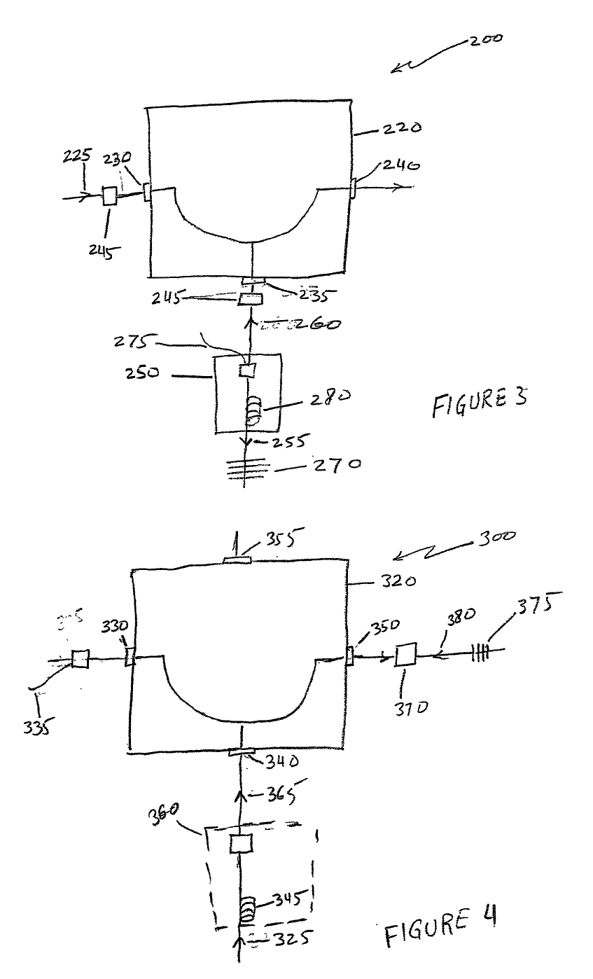

Now referring to FIG. 3, another example embodiment of the invention is seen. In this example, a system 200 for gaining and separating signals from a wavelength multiplexed signal 225 is provided, using an optical circulator 220, for example an optical circulator 220 having model number CIR10AN32N-00 manufactured by New Focus, Inc. Other optical circulators 220 will occur to those of skill in the art without departing from the scope of the present invention. The optical circulator 220 has a first port 230 positioned and arranged to receive the wavelength multiplexed signal 225, a second port 235 positioned and arranged to output the wavelength multiplexed signal 225 and receiving input signals, and a third port 240 positioned and arranged to output signals input at the second port. The system 200 comprises: means 245 that will occur to those of skill in the art for receiving the wavelength multiplexed signal 225 from the second port 235 that will occur to those of skill in the art for amplifying the wavelength multiplexed signal 225, wherein an amplified signal 255 results; and means 270 that will occur to those of skill in the art for reflecting a component of the amplified signal 260, said component having a selected wavelength, into the second port 235, wherein the component exits through the third port 240.

In an example embodiment of the system 200, said means 250 for amplifying the wavelength multiplexed signal 225 comprises means 275 for optically pumping the wavelength multiplexed signal 225 in a doped fiber amplifier 280 attached to the second port 235. The doped fiber amplifier 280 comprises an erbium doped fiber amplifier, in some example embodiments, and other dopants that will occur to those of skill in the art. In an alternative example embodiment, the system 200 further comprises means for applying the amplified signal 255 to a fiber Bragg grating 270, wherein the component of the amplified signal 260 reflects back into the second port 235.

In the illustrated example embodiment shown in FIG. 1, the erbium doped fiber amplifier 280 twice amplifies the signal 260 that is separated from the input signal 225. The advantage of double signal amplification, integral with the operation of signal separation, improves signal noise ratio over a predetermined signal path.

Now referring to FIG. 4, yet another example embodiment of the invention is seen in which system 300 is provided for gaining and separating optical signals from a wavelength multiplexed signal 325, using an optical circulator 320. The optical circulator 320 has a first port 330 positioned and arranged to receive an optical pump input 335, a second port 340 positioned and arranged to output signal received from the first port and to receive the wavelength multiplexed signal 325 through an optical fiber amplifier 345, a third port 350 positioned and arranged to output signals input at the second port 340 and receiving input signals, and a fourth port 355 positioned and arranged to output signals input at the third port 350. The system 300 comprises: means 360 for amplifying and receiving the wavelength multiplexed signal 325 in the second port 340, wherein an amplified signal 365 results; means 370 for outputting the amplified signal from the third port; and means 375 for reflecting a component of the amplified signal 380, said component having a selected wavelength, into the third port 350, wherein the component exits through the fourth port 355.

In an alternative example embodiment of the invention, said means 360 for amplifying the wavelength multiplexed signal 325 comprises means 360 for optically gaining the wavelength multiplexed signal 325 in a doped fiber amplifier 345 attached to the second port 340. In an example embodiment said doped fiber amplifier 345 comprises an erbium doped fiber amplifier. Acceptable means 360 for optically pumping the wavelength multiplexed signal 325 will occur to those of skill in the art. In one example, the optical pumping is performed using an optical pump 335 attached to the first port 330. Another example embodiment further comprises means 370 for applying the amplified signal to a fiber Bragg grating, wherein the component of the amplified signal 380 reflects back into the third port 350. Acceptable means 370 for applying the amplified signal to the fiber Bragg grating will occur to those of skill in the art.

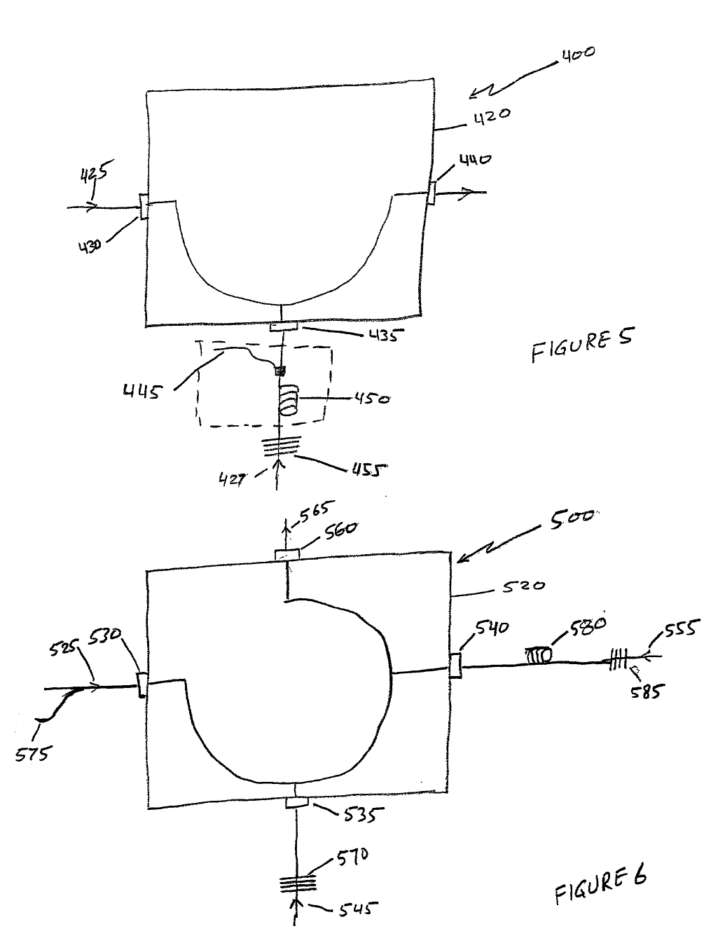

Now referring to FIG. 5, a still another example embodiment of the invention is seen in which an apparatus 400 for multiplexing optical signals is provided. The apparatus 400 comprises an optical circulator 420, for example an optical circulator 420 having model number CIR10AN32N-00 manufactured by New Focus, Inc. Other optical circulators 420 will occur to those of skill in the art without departing from the scope of the present invention. The apparatus 400 further comprises the optical circulator having a first port 430 positioned and arranged to receive a first signal 425, a second port 435 positioned and arranged to output the first signal 425 and receive a second signal 427, and a third port 440 positioned and arranged to output signals input at the second port 435. The apparatus 400 further comprises an optical pump 445 optically coupled to the second port 435; a fiber amplifier 450 optically coupled to the optical pump 445; and a spectrally selective reflecting grating 455 optically coupled to the fiber amplifier 450.

In the example embodiment, the fiber amplifier 450 comprises an erbium doped fiber amplifier. In yet another example embodiment of the invention, the optical pump 445 further comprises the erbium doped fiber amplifier. In still another example embodiment, the spectrally selective reflecting grating 455 comprises a fiber Bragg grating. In yet another example embodiment, the apparatus 400 the fiber Bragg grating is integrally built in with the fiber amplifier 450.

In the illustrated example embodiment of FIG. 5, the erbium doped fiber amplifier 450 twice amplifies the first signal 425 and amplifies the second signal 427 once. The design of the apparatus 400 provides the advantage of signal amplification integral with the operation of signal multiplexing. Such enhanced signal amplification improves signal noise ratio over a predetermined signal path.

FIG. 6 shows a schematic of the apparatus 500 of another example embodiment of the invention for multiplexing signals. The apparatus 500 comprises an optical circulator 520 having a first port 530 positioned and arranged to receive an optical pump input 525, a second port 535 positioned and arranged to receive the optical pump input 525 and receive an input signal 545, a third port 540 positioned and arranged to output signals input at the second port 535 and receive input signals 555, and a fourth port 560 positioned and arranged to output signals 565 input at the third port 540. The apparatus 500 further comprises: a first spectrally selective reflecting grating 570 to reflect the optical pump 575 input, optically coupled to the second port 535; a fiber amplifier 580 optically coupled to the third port 540; and a second spectrally selective reflecting grating 585 that is similar to the first spectrally selective reflecting grating 570, to reflect the signal input in the second port 535, optically coupled to the fiber amplifier 580.

In another example embodiment, the optical pump 575 is optically coupled to the first port 530. The fiber amplifier 580 comprises an erbium doped fiber amplifier. In some embodiments of the invention the erbium doped fiber amplifier is integrally built in at the third port 540, and separately attached in other, as will occur to those of skill in the art. The first spectrally selective reflecting grating 570 and the second spectrally selective reflecting grating 585 comprise fiber Bragg gratings. In the example embodiment of FIG. 6, the erbium doped fiber amplifier 580 twice amplifies the first signal 525 reflected off of the fiber Bragg grating 570 and amplifies once the second signal 545.

Now referring to FIG. 7 is seen a system 600 for multiplexing optical signals using an optical circulator 620 having a first port 630 positioned and arranged to receive a first signal 625, a second port 635 positioned and arranged to output the first signal 625 and receive input signals, and a third port 640 positioned and arranged to output signals input at the second port 635. The system 600 comprises: means 645 for receiving the first signal 625 from the second port 635; means 650 for amplifying the first signal 625, wherein an first amplified signal 655 results; means 660 for reflecting the first amplified signal 655 back into the second port 635; means 650 for amplifying a second signal 665, wherein a second amplified signal 670 results; means 675 for inputting the second amplified signal 670 into the second port; and means for outputting 680 a multiplexed signal 685 through the third port 640.

In another example embodiment of the invention, said means 650 for amplifying the first signal 625, and said means 650 for amplifying the second signal 665 comprise means 690 for optically pumping the first signal 625 in a doped fiber amplifier 695 attached to the second port 635, and means 690 for optically pumping the second signal 665 in a doped fiber amplifier 695 attached to the second port 635. The doped fiber amplifier 695 comprises an erbium doped fiber amplifier. In one aspect of the example embodiment, the means 600 for reflecting the first signal comprises a spectrally selective reflecting grating 660. The spectrally selective reflecting grating 660 comprises a fiber Bragg grating.

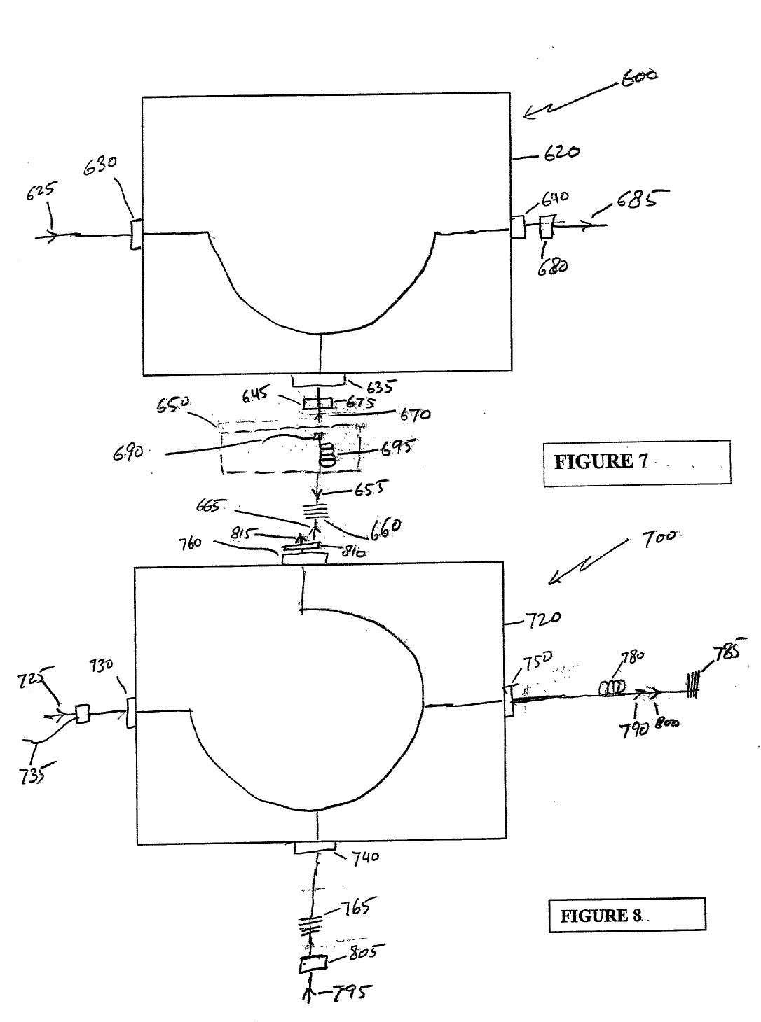

Now referring to FIG. 8 is seen yet another embodiment of a system 700 for multiplexing optical signals using an optical circulator 720. The circulator 720 comprises a first port 730 positioned and arranged to receive an optical pump input 735, a second port 740 positioned and arranged to receive the optical pump input 735 and receive a first signal 725, a third port 750 positioned and arranged to output signals input at the second port 740 and receive input signals, and a fourth port 760 positioned and arranged to output signals input at the third port 750. The system 700 comprises: means 765 for reflecting at the second port 740 the first signal 725 from the first port 730; means 780 for amplifying the first signal 725, wherein an first amplified signal 790 results; means 785 for reflecting the first signal 725 back into the third port 750; means 780 for amplifying a second signal 795, wherein a second amplified signal 800 results; means 805 for inputting the second signal 795 into the second port 740; means 785 for reflecting the second amplified signal 800 back into third port 750; and means 810 for outputting a multiplexed signal 815 through the fourth port 760.

In another aspect of the example embodiment of the invention, said means 780 for amplifying the first signal 725, and said means 780 for amplifying the second signal 795 comprise means 735 for optically pumping the first signal 725 in a doped fiber amplifier 780 attached to the third port 750, and means 735 for optically pumping the second signal 795 in the doped fiber amplifier 780 attached to the third port 750. In a yet another aspect of the example embodiment, said doped fiber amplifier 780 comprises an erbium doped fiber amplifier. In still another aspect of the example embodiment, the means 785 for reflecting the first signal comprises a spectrally selective reflecting grating 785. The spectrally selective reflecting grating 785 comprises a fiber Bragg grating.

While certain example embodiments of the invention have been described herein, the invention is not to be construed as being so limited, except to the extent that such limitations are found in the claims.

What is claimed is:

1. An apparatus for separating signals from a wavelength multiplexed signal, the apparatus comprising:
an optical circulator having a first port positioned and arranged to receive the wavelength multiplexed signal, a second port positioned and arranged to output the wavelength multiplexed signal, and a third port positioned and arranged to output signals input at the second port;
an optical pump optically coupled to the second port;
a fiber amplifier optically coupled to the optical pump; and
a spectrally selective reflecting grating optically coupled to the fiber amplifier.

2. An apparatus as in claim 1, wherein the fiber amplifier comprises an erbium doped fiber amplifier.

3. An apparatus as in claim 2, wherein the optical pump further comprises the erbium doped fiber amplifier.

4. An apparatus as in claim 1, wherein the spectrally selective reflecting grating is a fiber Bragg grating.

5. An apparatus as in claim 4, wherein the fiber Bragg grating is integrally built in with the fiber amplifier.

6. An apparatus for separating signals from a wavelength multiplexed signal, the apparatus comprising:
an optical circulator having a first port positioned and arranged to receive an optical pump input, a second port positioned and arranged to output signal received from the first port and to receive the wavelength multiplexed signal through a fiber amplifier, a third port positioned and arranged to output signals input at the second port and receiving input signals, and a fourth port positioned and arranged to output signals input at the third port;
an optical pump optically coupled to the first port;
the fiber amplifier optically coupled to the second port; and
a spectrally selective reflecting grating optically coupled to the third port.

7. An apparatus as in claim 6, wherein the optical pump is optically coupled to the first port.

8. An apparatus as in claim 6, wherein the fiber amplifier is an erbium doped fiber amplifier.

9. An apparatus as in claim 8, wherein the erbium doped fiber amplifier is integrally built in at the second port.

10. An apparatus as in claim 6, wherein the spectrally selective reflecting grating is a fiber Bragg grating.

11. An apparatus as in claim 10, wherein the fiber Bragg grating is integrally built in at the third port.

12. A system for separating signals from a wavelength multiplexed signal using an optical circulator, said optical circulator having a first port positioned and arranged to receive the wavelength multiplexed signal, a second port positioned and arranged to output the wavelength multiplexed signal and receiving input signals, and a third port positioned and arranged to output signals input at the second port, the system comprising:
means for receiving the wavelength multiplexed signal from the second port;
means for amplifying the wavelength multiplexed signal, wherein an amplified signal results; and
means for reflecting a component of the amplified signal, said component having a selected wavelength, into the second port, wherein the component exits through the third port.

13. A system as in claim 12, wherein said means for amplifying the wavelength multiplexed signal comprises means for optically pumping the wavelength multiplexed signal in a doped fiber amplifier attached to the second port.

14. A system as in claim 13, wherein said doped fiber amplifier comprises an erbium doped fiber amplifier.

15. A system as in claim 12, further comprising means for applying the amplified signal to a fiber Bragg grating, wherein the component of the amplified signal reflects back into the second port.

16. A system for separating optical signals from a wavelength multiplexed signal using an optical circulator, said optical circulator having a first port positioned and arranged to receive an optical pump input, a second port positioned and arranged to output signal received from the first port and to receive the wavelength multiplexed signal through a fiber amplifier, a third port positioned and arranged to output signals input at the second port and receiving input signals, and a fourth port positioned and arranged to output signals input at the third port, the system comprising:
means for amplifying and receiving the wavelength multiplexed signal in the second port, wherein an amplified signal results;
means for outputting the amplified signal from the third port; and
means for reflecting a component of the amplified signal, said component having a selected wavelength, into the third port, wherein the component exits through the fourth port.

17. A system as in claim 16, wherein said means for amplifying the wavelength multiplexed signal comprises means for optically pumping the wavelength multiplexed signal in a doped fiber amplifier attached to the second port.

18. A system as in claim 17, wherein said doped fiber amplifier comprises an erbium doped fiber amplifier.

19. A system as in claim 17, wherein the optical pumping is performed using an optical pump attached to the first port.

20. A system as in claim 19, further comprising means for applying the amplified signal to a fiber Bragg grating, wherein the component of the amplified signal reflects back into the third port.

21. A method of separating signals from a wavelength multiplexed signal using an optical circulator, said optical circulator having a first port positioned and arranged to receive the wavelength multiplexed signal, a second port positioned and arranged to output the wavelength multiplexed signal and receiving input signals, and a third port positioned and arranged to output signals input at the second port, the method comprising:
receiving the wavelength multiplexed signal from the second port;
amplifying the wavelength multiplexed signal, wherein an amplified signal results; and
reflecting a component of the amplified signal, said component having a selected wavelength, into the second port, wherein the component exits through the third port.

22. A method as in claim 21, wherein said amplifying the wavelength multiplexed signal comprises optically pumping the wavelength multiplexed signal in a doped fiber amplifier attached to the second port.

23. A method as in claim 22, wherein said doped fiber amplifier comprises an erbium doped fiber amplifier.

24. A method as in claim 21, further comprising applying the amplified signal to a fiber Bragg grating, wherein the component of the amplified signal reflects back into the second port.

25. A method of separating optical signals from a wavelength multiplexed signal using an optical circulator, said optical circulator having a first port positioned and arranged to receive an optical pump input, a second port positioned and arranged to output signal received from the first port and to receive the wavelength multiplexed signal through an optical pump, a third port positioned and arranged to output signals input at the second port and receiving input signals, and a fourth port positioned and arranged to output signals input at the third port, the method comprising:
amplifying and receiving the wavelength multiplexed signal in the second port, wherein an amplified signal results;
outputting the amplified signal from the third port; and
reflecting a component of the amplified signal, said component having a selected wavelength, into the third port, wherein the component exits through the fourth port.

26. A method as in claim 25, wherein said amplifying the wavelength multiplexed signal comprises optically pumping the wavelength multiplexed signal in a doped fiber amplifier attached to the second port.

27. A method as in claim 26, wherein said doped fiber amplifier comprises an erbium doped fiber amplifier.

28. A method as in claim 26, wherein the optical pumping is performed using an optical pump attached to the first port.

29. A method as in claim 25, further comprising applying the amplified signal to a fiber Bragg grating, wherein the component of the amplified signal reflects back into the third port.

30. An apparatus for multiplexing optical signals, the apparatus comprising:
an optical circulator having a first port positioned and arranged to receive a first signal, a second port positioned and arranged to output the first signal and receive input signals, and a third port positioned and arranged to output signals input at the second port;
an optical pump optically coupled to the second port;
a fiber amplifier optically coupled to the optical pump; and
a spectrally selective reflecting grating optically coupled to the fiber amplifier.

31. An apparatus as in claim 30, wherein the fiber amplifier comprises an erbium doped fiber amplifier.

32. An apparatus as in claim 31, wherein the optical pump further comprises the erbium doped fiber amplifier.

33. An apparatus as in claim 30, wherein the spectrally selective reflecting grating is a fiber Bragg grating.

34. An apparatus as in claim 33, wherein the fiber Bragg grating is integrally built in with the fiber amplifier.

35. An apparatus for multiplexing optical signals, the apparatus comprising:
an optical circulator having a first port positioned and arranged to receive an optical pump input, a second port positioned and arranged to receive the optical pump input and receive an input signal, a third port positioned and arranged to output signals input at the second port and receive input signals, and a fourth port positioned and arranged to output signals input at the third port;
a first spectrally selective reflecting grating to reflect the optical pump input optically coupled to the second port;
a fiber amplifier optically coupled to the third port; and
a second spectrally selective reflecting grating, to reflect the signal input in the second port, optically coupled to the fiber amplifier.

36. An apparatus as in claim 35, wherein the optical pump is optically coupled to the first port.

37. An apparatus as in claim 35, wherein the fiber amplifier is an erbium doped fiber amplifier.

38. An apparatus as in claim 37, wherein the erbium doped fiber amplifier is integrally built in at the third port.

39. An apparatus as in claim 35, wherein the first spectrally selective reflecting grating and the second spectrally selective reflecting grating are fiber Bragg gratings.

40. A system for multiplexing optical signals using an optical circulator having a first port positioned and arranged to receive a first signal, a second port positioned and arranged to output the first signal and receive input signals, and a third port positioned and arranged to output signals input at the second port, the system comprising:
means for receiving the first signal from the second port;
means for amplifying the first signal, wherein an amplified first amplified signal results;
means for reflecting the first amplified signal back into the second port;
means for amplifying a second signal, wherein a second amplified signal results;
means for inputting the amplified second signal into the second port; and
means for outputting a multiplexed signal through the third port.

41. A system as in claim 40, wherein said means for amplifying the first signal, and said means for amplifying the second signal comprise means for optically gaining the first signal in a doped fiber amplifier attached to the second port, and means for optically gaining the second signal in a doped fiber amplifier attached to the second port.

42. A system as in claim 41, wherein said doped fiber amplifier comprises an erbium doped fiber amplifier.

43. A system as in claim 40, wherein the means for reflecting the first signal comprises a spectrally selective reflecting grating.

44. A system as in claim 43, wherein the spectrally selective reflecting grating comprises a fiber Bragg grating.

45. A system of multiplexing optical signals using an optical circulator having a first port positioned and arranged to receive an optical pump input, a second port positioned and arranged to receive the optical pump input and receive a first signal, a third port positioned and arranged to output signals input at the second port and receive input signals, and a fourth port positioned and arranged to output signals input at the third port, the system comprising:
means for receiving the first signal from the third port;
means for amplifying the first signal, wherein an amplified first signal results;
means for reflecting the first signal back into the third port;
means for amplifying a second signal, wherein an amplified second signal results;
means for inputting the second signal into the third port; and
means for outputting a multiplexed signal through the fourth port.

46. A system as in claim 45, wherein said means for amplifying the first signal, and said means for amplifying the second signal comprise means for optically gaining the first signal in a doped fiber amplifier attached to the third port, and means for optically gaining the second signal in the doped fiber amplifier attached to the third port.

47. A system as in claim 46, wherein said doped fiber amplifier comprises an erbium doped fiber amplifier.

48. A system as in claim 45, wherein the means for reflecting the first signal comprises a spectrally selective reflecting grating.

49. A system as in claim 48, wherein the spectrally selective reflecting grating comprises a fiber Bragg grating.

50. A method of multiplexing optical signals using an optical circulator having a first port positioned and arranged to receive a first signal, a second port positioned and arranged to output the first signal and receive input signals, and a third port positioned and arranged to output signals input at the second port, the method comprising:
receiving the first signal from the second port;
amplifying the first signal, wherein an amplified first signal results;
reflecting the amplified signal back into the second port;
amplifying a second signal, wherein an amplified second signal results;
inputting the amplified second signal into the second port; and
outputting a multiplexed signal through the third port.

51. A method as in claim 50, wherein said amplifying the first signal, and said amplifying the second signal comprise optically gaining the first signal in a doped fiber amplifier attached to the second port, and optically gaining the second signal in a doped fiber amplifier attached to the second port.

52. A method as in claim 51, wherein said doped fiber amplifier comprises an erbium doped fiber amplifier.

53. A method as in claim 50, wherein the reflecting the first signal comprises reflecting the first signal from a spectrally selective reflecting grating.

54. A method as in claim 53, wherein the spectrally selective reflecting grating comprises a fiber Bragg grating.

55. A method of multiplexing optical signals using an optical circulator having a first port positioned and arranged to receive an optical pump input, a second port positioned and arranged to receive the optical pump input and receive a first signal, a third port positioned and arranged to output signals input at the second port and receive input signals, and a fourth port positioned and arranged to output signals input at the third port, the method comprising:
receiving the first signal from the third port;
amplifying the first signal, wherein an amplified first signal results;
reflecting the first signal back into the third port;
amplifying a second signal, wherein an amplified second signal results;
inputting the second signal into the third port; and
outputting a multiplexed signal through the fourth port.

56. A method as in claim 55, wherein said amplifying the first signal, and said amplifying the second signal comprise optically gaining the first signal in a doped fiber amplifier attached to the third port, and optically gaining the second signal in a doped fiber amplifier attached to the third port.

57. A method as in claim 46, wherein said doped fiber amplifier comprises an erbium doped fiber amplifier.

58. A method as in claim 45, wherein the reflecting the first signal comprises reflecting the first signal from a spectrally selective reflecting grating.

59. A method as in claim 48, wherein the spectrally selective reflecting grating comprises a fiber Bragg grating.
